(19) United States
(12) Patent Application Publication
(10) Pub. No.: US 2012/0166686 A1
(43) Pub. Date: Jun. 28, 2012

(54) METHOD, APPARATUS AND SYSTEM FOR AGGREGATING INTERRUPTS OF A DATA TRANSFER

(76) Inventors: Joerg Hartung, Vancouver (CA); Andrew Vogan, Aloha, OR (US)

(21) Appl. No.: 12/976,983

(22) Filed: Dec. 22, 2010

(51) Int. Cl. G06F 13/24

(52) U.S. Cl. 710/48

(57) ABSTRACT

A memory controller, and/or operation thereof, to generate a single interrupt for a plurality of data blocks which are the subject of a data transfer request. In an embodiment, a set of flags is allocated for the data transfer request, each flag corresponding to a respective one of the plurality of data blocks. In another embodiment, a single hardware interrupt is generated for all data which is the subject of the data transfer request, the generating based on an evaluation of the allocated set of flags.

### BACKGROUND

1. Technical Field

Embodiments generally relate to memory controller operations in support of a data transfer. More particularly, certain embodiments provide techniques for aggregating interrupts which are generated during a data transfer involving a plurality of data storage devices.

2. Background Art

Often, a storage controller for use in high performance data storage applications is configured to exchange data with multiple storage devices which connect to the storage controller in parallel with one another. Such storage devices can comprise a combination of one or more solid state drives (SSDs) and/or other such devices having, for example, non-volatile storage media such as NAND flash, phase change memory, and/or the like.

In such a parallel configuration, the storage devices are each coupled to their common storage controller through respective, independent data connections (referred to herein as memory channels). Such memory architecture could be required, for example, where respective bus bandwidths and/or the respective read or write latencies of individual storage devices might otherwise prevent the storage controller from satisfying a minimum threshold throughput capacity and/or some other performance requirement.

A memory controller for such storage devices often contain a processor—e.g. a central processing unit (CPU)—that reacts to data transaction requests of a host, including controlling operations of the individual storage devices. Hardware that performs the data transaction typically issues interrupts which each notify the CPU of completion of a respective component operation of the data transaction. There is a significant overhead associated with handling each such interrupt. Because a single host request can result in a number of hardware operations, the CPU has to process a lot of interrupts to service the single host request. As a result, memory systems have had to rely on improvements in CPU performance to remove interrupt handling bottlenecks, which degrade system performance. However, improved CPU performance is accompanied by increased power consumption and/or cost, for example.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating select elements of a computer platform for controlling a data transfer according to an embodiment.

FIG. 2 is a block diagram illustrating select elements of various formats for a data request message to initiate a data transfer according to an embodiment.

FIG. 3 is a block diagram illustrating select elements of a memory controller to aggregate interrupts of a data transfer according to an embodiment.

FIG. 4 is a block diagram illustrating select elements of a method for aggregating interrupts of a data transfer according to an embodiment.

FIG. 5 is a block diagram illustrating select elements of a memory controller to aggregate interrupts of a data transfer according to an embodiment.

### DETAILED DESCRIPTION

Certain embodiments provide for methods to aggregate multiple storage media data transfer completion events and/or data transformation completion events into a single processor interrupt. More particularly, a host process may provide to a memory controller a data transfer request which, for example, indicates a total amount of data to be exchanged in order to satisfy the data transfer request. This total amount of requested data may be partitioned into multiple—e.g. equally sized—amounts of transfer data (referred to herein as data blocks) which are variously stored in the multiple storage devices coupled to, and controlled by, the memory controller.

In an embodiment, the memory controller may include, or otherwise have access to, a flag array storing a set of data block status flags, each flag to store a flag value corresponding to a respective one of the multiple data blocks to be transferred. Each flag in the set of data block status flags may, for example, indicate a processing status of the corresponding data block. Additionally or alternatively, the memory controller may include, or otherwise have access to, logic to variously transform a given flag value of the set of data block status flags—e.g. according to a change of processing status of a corresponding data block.

By way of illustration and not limitation, data blocks may be stored during the data transfer in a memory buffer that is either internal or external to the memory controller—e.g. wherein the data blocks remain buffered until a single interrupt is generated for all requested data blocks of the data transfer. A flag value of the set of data block status flags may be transformed, for example, in response to detecting that a loading of a corresponding data block to (or from) the buffer has completed. Alternatively or in addition, a flag value of the set of data block status flags may be transformed in response to completing a verification of data integrity for a data block being transferred.

In an embodiment, the memory controller may include logic to perform one or more evaluations of the set of data block status flags—e.g. to detect for a condition which is to result in generation of the single interrupt. By way of illustration and not limitation, the single interrupt may be generated in response to identifying or otherwise detecting that every data block status flag for the data blocks of the data transfer is at a respective expected value. These expected values may indicate that respective data transfer and/or data transformation operations have finished for each data of the data blocks of the requested transfer. The single interrupt may be provided to a processor—e.g. one or more processing cores of the memory controller—which may initiate one or more interrupt handling routines to complete the data transfer requested by the host process.

In various embodiments, multiple respective interrupt state machines may check different respective portions of the flag array—e.g. each portion storing a different respective set of data block status flags for a different data transfer request. The portions of the flag array to be variously checked for different respective data transfer requests may be configured by firmware that is running on a processor of the memory controller. This ability to configure/reconfigure checking of the flag array provides highly granular and configurable interrupt aggregation mechanism which is readily adaptable to match implementation-specific system requirements.

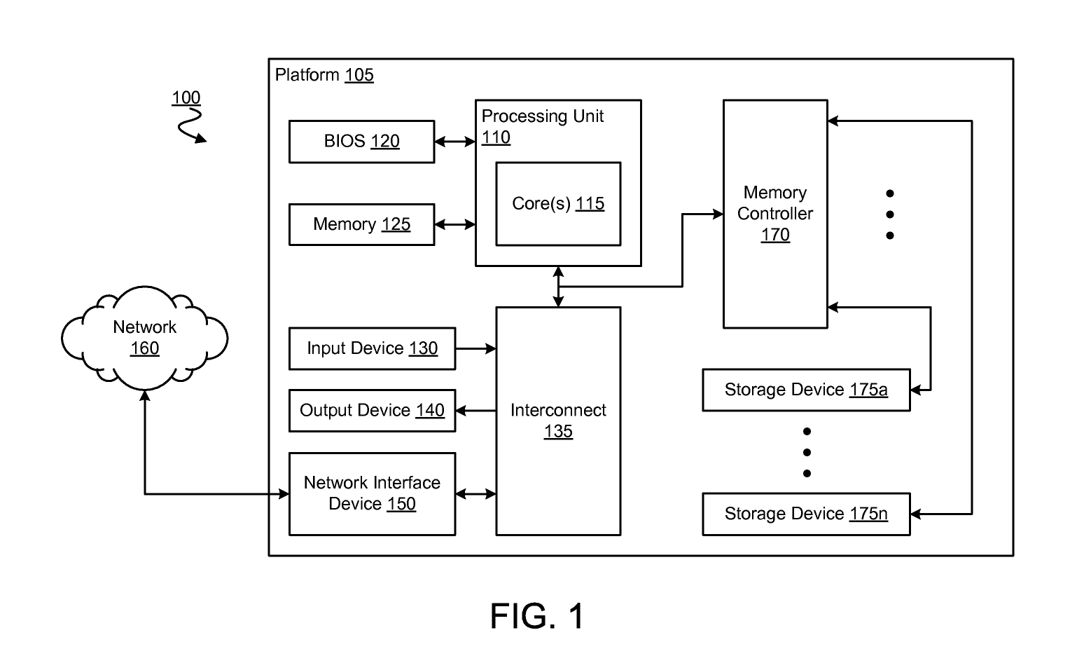

FIG. 1 illustrates select elements of a computer system 100 according to certain embodiments. In various embodiments, system 100 includes a platform 105 having data storage devices 175a, . . . , 175n, wherein data transfers to and/or from storage devices 175a, . . . , 175n may be controlled by a memory controller 170 of platform 105. Although the scope of the various embodiments is not limited in this respect, platform 105 may include one or more of a personal computer (PC), a personal digital assistant (PDA), an Internet appliance, a cellular telephone, a laptop computer, a tablet device, a mobile unit, a wireless communication device and/or any other such computing device.

According to illustrative embodiments, platform 105 may include a processing unit 110 which is directly or indirectly coupled to memory controller 170 and the data storage devices 175a, . . . , 175n which are coupled to memory controller 170 in parallel with one another—e.g. via independent memory channels. Processing unit 110 may include one or more cores 115 to execute a host operating system (OS), not shown. In various embodiments, the host OS, an application running thereon, and/or some other agent of platform 105 may send to memory controller 170 one or more requests to transfer respective data to and/or from data storage devices 175a, . . . , 175n. In an embodiment, a data transfer request received by memory controller 170 may include information specifying, or otherwise indicating, a total amount of data to be transferred in order to satisfy the data transfer request.

Memory 125 may include a dynamic random access memory (DRAM), a non-volatile memory, or the like. In one example, memory 125 may store a software program which may be executed by processing unit 110. Additionally or alternatively, processing unit 110 may have access to Basic Input/Output System (BIOS) instructions 120—e.g. stored in memory 125 or in a separate storage device 120. In an embodiment, memory 125 and/or storage device 120 may include a dynamic random access memory (DRAM) device.

Processing unit 110 may be coupled to one or more other components of platform 105—e.g. a memory 125 for use in executing the host OS and an interconnect 135 to provide the host OS with access to various platform functionality. By way of illustration and not limitation, one or more data busses, address busses, control lines, crossbars, etc. may variously connect processing unit 110 to a device or devices other than memory controller 170 and data storage devices 175a, . . . , 175n. Interconnect 135 may couple various components of platform 105 to one another for various exchanges of data and/or control messages. By way of illustration and not limitation, interconnect 135 may include one or more of an I/O controller hub, a platform controller hub, a memory controller hub, and/or the like. In an alternate embodiment, memory controller 170 may be integrated into circuitry of interconnect 135.

In order to illustrate various features of certain embodiments, interconnect 135 is shown coupling processing unit 110 to an input device 130 for receiving communications at platform 105, an output device 140 for sending communications from platform 105 and a network interface device 150 for coupling platform 105 to a network 160. By way of illustration and not limitation, either or both of input device 130 and output device 140 may include one or more of a keyboard, keypad, mouse, touchpad, touch screen, display, biometric device, and the like. It is understood that any of a variety of additional or alternative devices, circuit blocks, etc. of platform 105 may be interconnected via interconnect 135, according to various embodiments. It is also understood that the particular architecture of platform 105—e.g. the relative configuration of devices, circuit blocks, etc. of platform 105 with respect to at least memory controller 170 and the parallel coupled storage devices 175a, . . . , 175n—is not limiting on certain embodiments.

Platform 105 may exchange data with other devices via a connection to a network 160 of system 100. For example, platform 105 may include network interface device 150—e.g. a network interface card, a wireless network interface and/or one or more antennae—to exchange network traffic with network 160. The network connection may include any type of network connection, such as an Ethernet connection, a digital subscriber line (DSL), a telephone line, a coaxial cable, etc. Network 160 may be any type of network, such as the Internet, a telephone network, a cable network, a wireless network such as, for example, a network complying IEEE standard 802.11, 1999 include one or more IEEE 802.11 related standards, IEEE 802.16 Standard for Wireless Metropolitan Area Networks and/or the like.

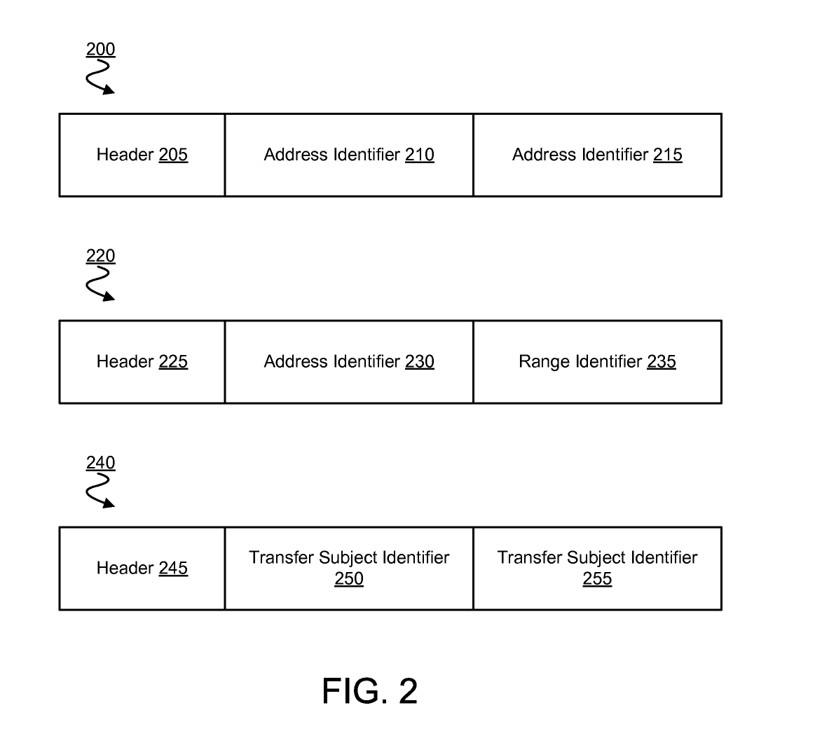

FIG. 2 illustrates select elements of various exemplary formats 200, 220, 240 of a data transfer request received by a memory controller, according to an embodiment. A request having one of formats 200, 220, 240 may be provided, for example, to memory controller to request data from data storage devices 175a, . . . , 175n. In an alternative embodiment, the memory controller may exchange data with a plurality of storage devices which are external to, coupled via different respective memory channels to, a computer platform in which the memory controller resides—e.g. wherein the a plurality of storage devices are coupled to the computer platform in parallel with one another.

Format 200 may include a header field 205 to contain, for example, what is referred to herein as transfer control information—i.e. information specifying or otherwise indicating how the data which is the subject of the data transfer request is to be transferred. For example, control information in header field 205 may include one or more of information to identify the request as being a data transfer request, a required QoS for the transfer, an identifier of an error handling response for use during the transfer, and/or the like. Although shown as residing in a single header field 205, it is understood that such transfer control information may, according to different embodiments, be located in one or more additional or alternative locations of a packet or packets for communicating a data transfer request.

Format 200 may further additionally or alternatively include one or more fields to store what is referred to herein as transfer subject information—i.e. information specifying, or otherwise indicating, which data which is to be the subject of the data transfer request. In an embodiment, transfer subject information may indicate a total amount of data which is to be transferred in order to satisfy the transfer request. For example, the total amount of data may refer to all data which is to be exchanged during the transferring which is otherwise performed according to the transfer control information of the transfer request.

By way of illustration and not limitation, transfer subject information may be stored in address identifier fields 210, 215. In an embodiment, address identifier fields 210, 215 may store respective ones of (1) start address information such as an address or pointer identifier for determining a beginning of a memory range storing data which is the subject of the transfer request, and (2) final address information such as an address or pointer identifier for determining an final end of the memory range. Format 200 may include one or more additional such address identifier fields (not shown)—e.g. for identifying non-contiguous address ranges to be accessed for the data transfer request.

Format 220 illustrates an alternative representation of transfer source information from that of format 200. It is understood that a data request according to format 220 may, for example, store transfer control information in a manner such as that discussed above with respect to format 200—e.g. in a header field 225.

Format 220 may store transfer subject information in an address identifier field 230 and a range field 235. In an embodiment, address identifier field 230 may store an address or pointer identifier for determining a terminus (e.g. beginning or end) of a memory range storing data which is the subject of the transfer request. By contrast, range field 235 may store an identifier of some amount of data in the memory range. Format 220 may include one or more additional such pairs of address identifier field and range field—e.g. for identifying non-contiguous memory ranges to be accessed for the data transfer request.

Format 240 illustrates an alternative representation of transfer source information from that of formats 200, 220. It is understood that a data request according to format 240 may, for example, store transfer control information in a manner such as that discussed above with respect to format 200—e.g. in a header field 245.

Format 240 may store transfer subject information in one or more transfer subject identifier fields 250, . . . , 255—e.g. where each transfer subject identifier field stores a single identifier for determining both a location and an amount of data to be transferred. By way of illustration and not limitation, transfer subject identifier fields 250, . . . , 255 may each store respective single identifier—e.g. where a memory controller may include or otherwise have access to a lookup table or other data source for determining an location and amount of data which corresponds to the single identifier. It is understood that any of a variety of additional or alternative data request formatting techniques may be used to convey transfer subject information, as distinguished from transfer control information, e.g. using some combination of elements from formats 200, 220, 240.

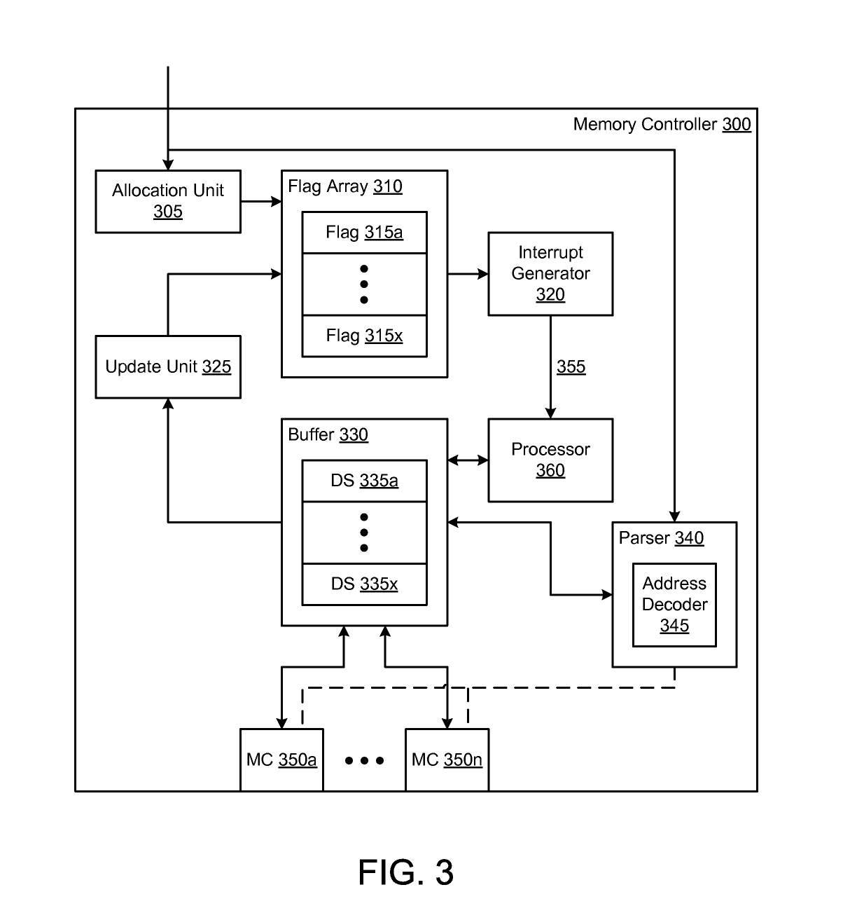

FIG. 3 illustrates select elements of a memory controller 300 for aggregating interrupts for a data transfer according to an embodiment. Memory controller may include some or all of the features of memory controller 170, for example. In an embodiment, a plurality of memory storage devices (not shown) are to couple to memory controller 300 in parallel with one another—e.g. wherein each memory storage device is coupled via a different respective one of memory channels MC 350a, . . . , 350n.

Memory controller 300 may receive a data transfer request—e.g. from a host OS or other agent residing on a computer platform in which memory controller 300 operates—for a transfer of data to or from the plurality of memory storage devices. The received data request may identify or otherwise indicate data which is the subject of the data request—e.g. including indicating a total amount of data which is to be transferred in order to satisfy the date request.

The data request may be provided to an allocation unit 305 of memory controller 300. Allocation unit 305 may include logic—e.g. hardware and/or executing software—to identify a number of data blocks that comprise the total amount of data which is the subject of the data transfer request. By way of illustration and not limitation, a total number of such data blocks may be determined based on some standard incremental amount of data to be referenced for such data transfers—e.g. a known minimal size of data blocks to be referred to or otherwise used by memory controller 300 in exchanges with the plurality of memory storage devices.

Allocation unit 305 may allocate a set of flags 315a, . . . , 315x of a flag array 310 in memory controller 300 based on the identified total number of data blocks which are the subject of the data transfer request. In an embodiment, the total number of flags in the allocated set of flags 315a, . . . , 315x is equal to the identified total number of data blocks—e.g. where each of the data blocks comprising the subject of the data request corresponds to a different respective one or the allocated set of flags 315a, . . . , 315x.

Parser logic 340 of memory controller 300 may receive a version of the data transfer request—e.g. a version of the request as initially provided to memory controller 300. Parser logic 340 may convert the data transfer request into a set of component requests, where each component request is for a different respective one of the data blocks which comprise the subject of the original data transfer request. In an embodiment, parser logic may include or otherwise have access to address decoder logic 345 to assure correct addressing for the individual component requests. The individual component requests generated by parser 340 may be sent via various ones of the memory channels MC 350a, . . . , 350n to respective ones of the plurality of data storage devices coupled to memory controller 300.

In the course of responding to the component requests, various ones of the plurality of data storage devices coupled via memory channels MC 350a, . . . , 350n may provide data blocks to memory controller 300—i.e. where the data transfer request is request to read from the data storage devices. By way of illustration and not limitation, in such a case, individual data blocks comprising the subject of the data transfer request may be written at various times as respective ones of data blocks DB 335a, . . . , 335x in buffer 330. In an embodiment, the memory controller may not know in advance a particular timing or order in which the data blocks DB 335a, . . . , 335x will be written to buffer 330.

Continuing with the read request scenario, as various ones of data blocks DB 335a, . . . , 335x are being processed for the data transfer request, a update unit 325 of memory controller may update corresponding ones of flags 315a, . . . , 315n—e.g. to reflect a change of processing status for those ones of data blocks DB 335a, . . . , 335x. In an embodiment, updating a flag value stored in a given flag may be to indicate an opportunity to generate a hardware interrupt on behalf of the data block corresponding to that flag. Nevertheless, in an embodiment, no interrupt to handle any data block of a requested transfer is to be generated until a single interrupt can be generated to handle all data blocks of that requested data transfer.

By way of illustration and not limitation, update unit 325 may change a flag value stored in flag 315a in response to detecting that a data block corresponding to update flag 315a has completed being written to buffer 330 as DB 335a. In an embodiment, updating a flag value may performed based on a data block transfer being detected at a memory channel—e.g. as opposed to detecting corresponding operations in buffer 330. For example, update unit 325 may be integrated into memory channels MC 350a, . . . , 350n, in various embodiments. Alternatively or in addition, the changing of the flag value stored in flag 315a may be in response to a completion of a verification of data integrity for the data block stored in—or to be stored in—DB 335a. It is understood that any of a variety of additional or alternative flag update operations may be performed, according to various embodiments, and that the particular relation of flags in flag array 310 to buffer locations in buffer 330 is not limiting on certain embodiments.

As the set of flags 315a, . . . , 315n is being updated by update unit 325, interrupt generator logic 320 may evaluate the set of flags 315a, . . . , 315n on one or more occasions—e.g. to detect for a condition which is to result in generation of the single interrupt for all of the data which is the subject of the data transfer request. For example, in an embodiment, no hardware interrupt other than the single interrupt may be generated by the memory controller 300 to handle a data block for the data transfer request.

By way of illustration and not limitation, the single interrupt may be generated in response to identifying or otherwise detecting that every one of flags 315a, . . . , 315n stores a respective expected flag value. In an embodiment, these expected flag values may indicate that respective data transfer, data integrity checks, data transformation operations and/or the like have finished for each data block comprising the requested data transfer.

In response to detecting that all of flags 315a, . . . , 315n store their respective expected flag value, interrupt generator 320 may generate a single interrupt 355—e.g. a hardware interrupt signal to firmware running on a processor 360 of memory controller 300. Based on the single interrupt 355, processor 360 may initiate one or more interrupt handling processes to handle all of the data blocks 335a, . . . , 335x in buffer 300 which comprise the subject of the data transfer request. For example, processor 360 may initiate one or more interrupt handling processes to offload data blocks DB 335a, . . . , 335x via an output data transfer unit (not shown) of memory controller 300.

In an embodiment, various logic of memory controller 300—e.g. parser 340 and/or allocation unit 305—may be implemented by one or more processes executing on processor 360.

For a scenario in which the data transfer is a request to write data to the plurality of data storage devices, the flow of data passing through buffer 300 may be reversed, whereas other logic of memory controller 300 may operate as described above. More particularly, data blocks of a data write request may be stored to respective data blocks in buffer 330 while parser 340 parses the data write request into individual component requests.

As data blocks are being written out of buffer 330 into respective ones of the plurality of data storage devices, update unit 325 may update flags in flag array 310 to reflect changes in respective processing status for individual data blocks. In one embodiment, updating flags in flag array 310 may be performed by update logic 325 detecting data exchanges at various ones of memory channels 350a, . . . , 350n. Interrupt generator 320 may generate another single interrupt based on evaluation of a set of flags which indicates that each data blocks for the data write request has completed some processing stage—e.g. including completion of one or more of a data transfer, a data integrity check and/or a data transformation.

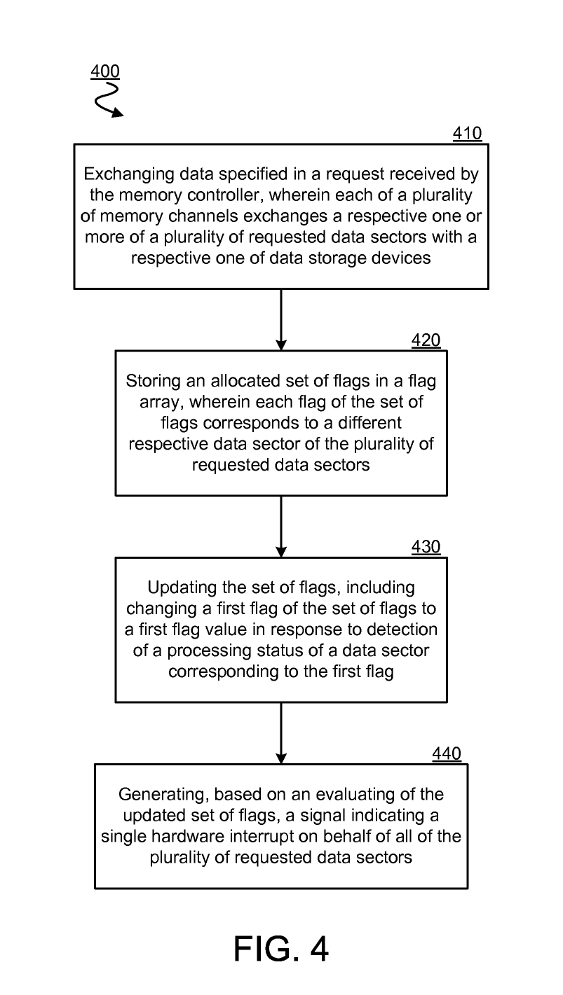

FIG. 4 illustrates select elements of a method 400 for aggregating interrupts according to an embodiment. Method 400 may be performed, for example, by memory controller 300.

In an embodiment, method 400 may include, at 410, a plurality of memory channels of the memory controller, exchanging data specified in a request received by the memory controller. The memory controller may be coupled to a plurality of data storage devices via the plurality of memory channels—e.g. wherein the data storage devices are coupled to the memory controller in parallel with one another. In an embodiment, a data transfer request is received which indicates a total number of a plurality of data blocks to be exchanged in order to satisfy the data transfer request. Performing the requested transfer may include each of the memory channels exchanging a respective one or more of the plurality of data blocks with a respective one of a plurality of data storage devices.

Additionally or alternatively, method 400 may include, at 420, storing in a flag array an allocated set of flags, wherein each flag of the set of flags corresponds to a different respective data block of the plurality of data blocks. Each flag in the set of flags may store a flag value which, for example, represents some processing state of a data block which corresponds to that flag. For example, a flag value may indicate a state of processing specific to that data block. The state of processing may include one or more of a state of transferring the corresponding data block to an intermediary buffer in the memory controller, a state of data integrity evaluation for the data block, a state of transforming data of the data block to restore data integrity, and/or the like.

Additionally or alternatively, method 400 may include, at 430, updating the allocated set of flags, including changing a first flag of the set of flags to a first flag value in response to detection of a processing status of a data block corresponding to the first flag. The updating of the set of flags may take place at regular intervals during performance of the requested data transfer.

Additionally or alternatively, method 400 may include, at 440, generating, based on an evaluating of the updated set of flags, a signal indicating a single hardware interrupt on behalf of all of the plurality of data blocks. The evaluating may identify or otherwise detect that every flag of the set allocated set of flags stores a respective expected flag value. These expected flag values may indicate, for example, that respective data transfer, integrity check and/or data transformation operations have successfully completed for each data segment corresponding to one of the set of flags.

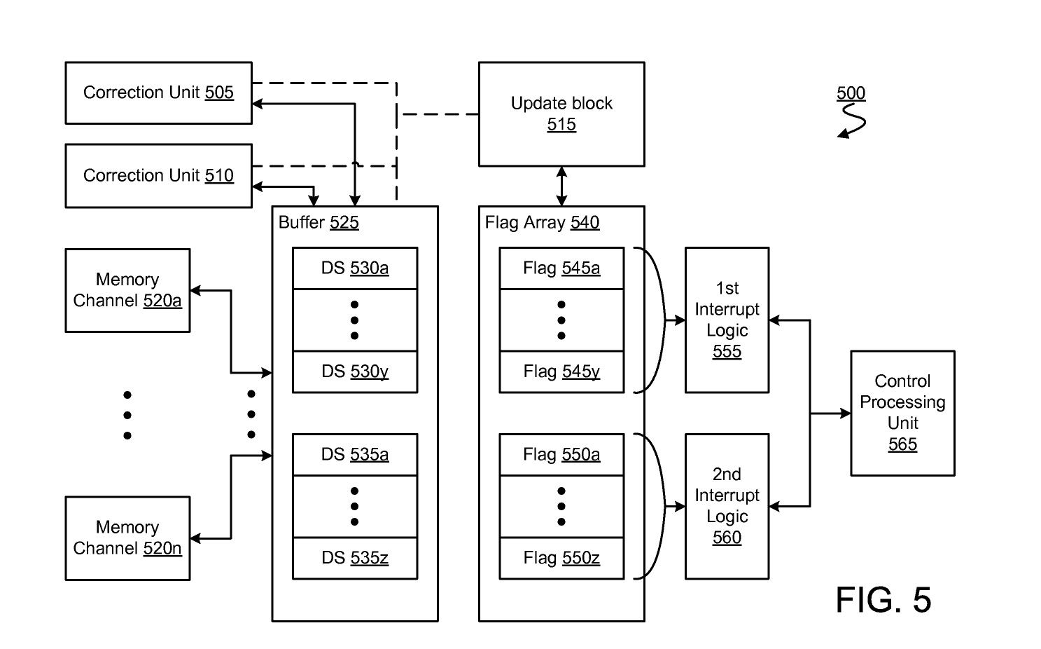

FIG. 5 illustrates select elements of a memory controller 500 for generating an aggregated interrupt according to an embodiment. Memory controller 500 may include some or all of the features of memory controller 300, for example. More particularly, memory controller 500 may extend at least some of the functionality discussed herein with respect to memory controller 300. For the sake of clarity in describing certain features of various embodiments, certain implementing logic shown in memory controller 300 has been left out of the illustration of memory controller 500.

Memory controller 500 may include memory channels 520a, . . . , 520n, each to coupled memory controller 500 to a different respective data storage device. In response to receiving a first data transfer request, a first set of flags 545a, . . . , 545y may be allocated in a flag array 540 of memory controller 500. Additionally or alternatively, in response to receiving a second data transfer request, a second set of flags 550a, . . . , 550z may be allocated in flag array 540.

In an embodiment, memory controller 500 may service both the first data transfer request and the second data transfer request concurrently. For example, the data blocks comprising the data which is the subject of the first data transfer request may be written as respective ones of data blocks 530a, . . . , 530y in a buffer 525 of memory controller 500. As various ones of data blocks 530a, . . . , 530n are being written to buffer 525, data blocks for the data which is the subject of the first data transfer request may also be written to buffer 525—e.g. as respective ones of data blocks 535a, . . . , 535z. It is understood that any of a variety of combinations of additional or alternative data requests may be services concurrently by memory controller 500, according to various embodiments.

As various ones of data blocks 530a, . . . , 530y and/or data blocks 535a, . . . , 535z are being written to buffer 525, the first set of flags 545a, . . . , 545y and/or the second set of flags 550a, . . . , 550z may be variously updated on occasion—e.g. by a update block 515 in memory controller 500. Updating a flag in flag array 540 may be to indicate an opportunity to generate a hardware interrupt on behalf of a data block corresponding to that flag.

By way of illustration and not limitation, update block 515 may include logic to detect from buffer 525—or from a detection point at one of memory channels 520a, . . . , 520n—that a particular data block has completed a transfer to buffer 525. In an embodiment, detection and/or signaling logic of update block 515 may be integrated into memory channels 520a, . . . , 520n. Update block 515 may then update a corresponding flag value of a flag in flag field 540 in response to detecting the completed transfer. Additionally or alternatively, update block 515 may update the flag value of a given flag in response to detecting that a data integrity evaluation for a corresponding data block has been completed. Additionally or alternatively, update block 515 may update the flag value of the given flag in response to detecting that a data correction operation has completed to restore data integrity of the corresponding data block. It is understood that any of a variety of additional or alternative data transformation logic may process data blocks for the data request, where processing by such data transformation logic may be an additional or alternative basis for updating a flag in flag array 540.

For example, memory controller 500 may include one or more correction units 505, . . . , 510 to evaluate data integrity of a data block and/or to perform a correction operation for assuring data integrity of the data block. Evaluating data integrity may, for example, include performing a hash, checksum, parity value, cyclic redundancy check (CRC) or other error detection evaluation for the data block. A correction operation for assuring data integrity of the data block may, for example, include performing an error correction code (ECC) calculation or a data block re-request. Memory controller 500 may dedicate correction units 505, . . . , 510 to supporting only respective ones of concurrent data transfer requests or, alternatively, may share either or all of correction units 505, . . . , 510 for supporting multiple concurrent data transfer requests.

As they are updated, the first set of flags 545a, . . . , 545y and/or the second set of flags 550a, . . . , 550z may be occasionally and/or variously evaluated—e.g. by first interrupt logic 555 and second interrupt logic 560 of memory controller 500, respectively. Memory controller 500 may dedicate first interrupt logic 555 and second interrupt logic 560 to supporting only respective ones of concurrent data transfer requests or, alternatively, may share either or all of first interrupt logic 555 and second interrupt logic 560 for supporting multiple concurrent data transfer requests. In various embodiments, memory controller 500 includes various additional or alternative interrupt logic units, each for independently evaluating one or more sets of flags for respective data transfer requests.

In an embodiment, first interrupt logic 555 may evaluate first set of flags 545a, . . . , 545y—e.g. to detect for a condition which is to result in generation of a first single interrupt for all of the data which is the subject of the first data transfer request. Additionally or alternatively, second interrupt logic 560 may evaluate second set of flags 550a, . . . , 550z—e.g. to detect for a condition which is to result in generation of a second single interrupt for all of the data which is the subject of the second data transfer request.

By way of illustration and not limitation, the first single interrupt may be generated in response to identifying or otherwise detecting that every one of first set of flags 545a, . . . , 545y stores a respective expected flag value. Alternatively or in addition, the second single interrupt may be generated in response to identifying or otherwise detecting that every one of second set of flags 550a, . . . , 550z stores a respective expected flag value. In an embodiment, these expected flag values may indicate that respective data transfer, data integrity checks, data transformation operations and/or the like have finished for each data block comprising the requested data transfer.

Based on the evaluation of first set of flags 545a, . . . , 545y, first interrupt logic 555 may provide the first single interrupt to a control processing unit 565 of memory controller 500. Alternatively or in addition, based on the evaluation of second set of flags 550a, . . . , 550z, second interrupt logic 560 may provide the second single interrupt to control processing unit 565. Control processing unit 565 may variously respond to the first and second single interrupts, e.g. by initiating for each interrupt one or more respective interrupt handling processes to handle data blocks 530a, . . . , 530y and/or data blocks 535a, . . . , 535z in buffer 525.

Techniques and architectures for determining an aggregation of interrupts for a data transfer are described herein. In the description herein, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A memory controller comprising:
a plurality of memory channels to exchange data specified in a request received by the memory controller, the request indicating a total number of a plurality of data blocks to be exchanged in order to satisfy the request, wherein each of the memory channels exchanges a respective one or more of the plurality of data blocks with a respective one of a plurality of data storage devices;
a flag array to store an allocated set of flags, each flag corresponding to a different respective data block of the plurality of data blocks;
an update unit to update the set of flags, including the update unit to change a first flag of the set of flags to a first flag value in response to detection of a processing status of a data block corresponding to the first flag; and
an interrupt generator to evaluate the updated set of flags and to generate, based on the evaluating, a signal indicating a single hardware interrupt on behalf of all of the plurality of data blocks.

2. The memory controller of claim 1, wherein the first flag value is stored in the first flag to indicate an opportunity to generate a hardware interrupt on behalf of the data block corresponding to the first flag

3. The memory controller of claim 1, further comprising a flag allocation unit responsive to the message to allocate the set of flags in the flag array as being associated with the plurality of data blocks.

4. The memory controller of claim 3, wherein the allocation unit to identify the total number of the plurality of data blocks based on the message, wherein allocation of the set of flags is based on identification of the total number of the data blocks.

5. The memory controller of claim 1, wherein the evaluating the set of flags includes identifying that each of the set of flags stores a respective value indicating an opportunity to generate an interrupt on behalf of a corresponding data block.

6. The memory controller of claim 1, wherein the evaluating the set of flags includes identifying that one of the set of flags does not store a value indicating an opportunity to generate an interrupt, wherein none of the set of flags other than the one of the set of flags is evaluated by the interrupt generator until the one of the set of flags is determined by the interrupt generator to indicate an opportunity to generate an interrupt.

7. The memory controller of claim 1, further comprising a corrector to correct a corrupted data block of the specified data, the corrector further to generate a signal indicating correction of the corrupted data block, wherein a flag value is stored in one of the set of flags based on the signal indicating correction of the corrupted data block.

8. The memory controller of claim 1, wherein a flag value is stored in one of the set of flags in response to the update unit detecting a completion of an exchange of a data block.

9. The memory controller of claim 8, wherein the flag value is stored in the one of the set of flags further in response to the update unit detecting an indication that the data block is not corrupt.

10. A system comprising:
a dynamic random access memory (DRAM);
a processor coupled to the DRAM, the processor to execute an operating system; and
a memory controller coupled to the processor, the memory controller including:
a plurality of memory channels to exchange data specified in a request received by the memory controller, the request indicating a total number of a plurality of data blocks to be exchanged in order to satisfy the request, wherein each of the memory channels exchanges a respective one or more of the plurality of data blocks with a respective one of a plurality of data storage devices;
a flag array to store an allocated set of flags, each flag corresponding to a different respective data block of the plurality of data blocks;
an update unit to update the set of flags, including the update unit to change a first flag of the set of flags to a first flag value in response to detection of a processing status of a data block corresponding to the first flag; and
an interrupt generator to evaluate the updated set of flags and to generate, based on the evaluating, a signal indicating a single hardware interrupt on behalf of all of the plurality of data blocks.

11. The system of claim 10, wherein the first flag value is stored in the first flag to indicate an opportunity to generate a hardware interrupt on behalf of the data block corresponding to the first flag

12. The system of claim 10, the memory controller further comprising a flag allocation unit responsive to the message to allocate the set of flags in the flag array as being associated with the plurality of data blocks.

13. The system of claim 10, wherein the evaluating the set of flags includes identifying that each of the set of flags stores a respective value indicating an opportunity to generate an interrupt on behalf of a corresponding data block.

14. The system of claim 10, wherein the evaluating the set of flags includes identifying that one of the set of flags does not store a value indicating an opportunity to generate an interrupt, wherein none of the set of flags other than the one of the set of flags is evaluated by the interrupt generator until the one of the set of flags is determined by the interrupt generator to indicate an opportunity to generate an interrupt.

15. The system of claim 10, the memory controller further comprising a corrector to correct a corrupted data block of the specified data, the corrector further to generate a signal indicating correction of the corrupted data block, wherein a flag value is stored in one of the set of flags based on the signal indicating correction of the corrupted data block.

16. The system of claim 10, wherein a flag value is stored in one of the set of flags in response to the update unit detecting a completion of an exchange of a data block.

17. The system of claim 10, wherein the flag value is stored in the one of the set of flags further in response to the update unit detecting an indication that the data block is not corrupt.

18. A method performed at a memory controller, the method comprising:
with a plurality of data ports, exchanging data specified in a request received by the memory controller, the request indicating a total number of a plurality of data blocks to be exchanged in order to satisfy the request, wherein each of the memory channels exchanges a respective one or more of the plurality of data blocks with a respective one of a plurality of data storage devices;
storing an allocated set of flags in a flag array, wherein each flag of the set of flags corresponds to a different respective data block of the plurality of data blocks;
updating the set of flags, including changing a first flag of the set of flags to a first flag value in response to detection of a processing status of a data block corresponding to the first flag; and
generating, based on an evaluating of the updated set of flags, a signal indicating a single hardware interrupt on behalf of all of the plurality of data blocks.

19. The method of claim 18, further comprising:
in response to the message, allocating the set of flags in the flag array as being associated with the plurality of data blocks.

20. The method of claim 18, wherein the evaluating of the set of flags includes identifying that each of the set of flags stores a respective value indicating an opportunity to generate an interrupt on behalf of a corresponding data block.

21. The method of claim 18, further comprising:
correcting a corrupted data block of the specified data, the corrector further to generate a signal indicating correction of the corrupted data block, wherein a flag value is stored in one of the set of flags based on the signal indicating correction of the corrupted data block.

22. The method of claim 18, wherein a flag value is stored in one of the set of flags in response to detection by the update unit of a completion of an exchange of a data block.

23. The method of claim 18, wherein the flag value is stored in the one of the set of flags further in response to detection by the update unit of an indication of a data integrity of the data block.

24. A computer readable storage media having instructions stored thereon which, when executed by one or more processors, cause the one or more processors to:
exchange, with a plurality of data ports, data specified in a request received by the memory controller, the request indicating a total number of a plurality of data blocks to be exchanged in order to satisfy the request, wherein each of the memory channels exchanges a respective one or more of the plurality of data blocks with a respective one of a plurality of data storage devices;
store an allocated set of flags in a flag array, wherein each flag of the set of flags corresponds to a different respective data block of the plurality of data blocks;
update the set of flags, including changing a first flag of the set of flags to a first flag value in response to detection of a processing status of a data block corresponding to the first flag; and
generate, based on an evaluating of the updated set of flags, a signal indicating a single hardware interrupt on behalf of all of the plurality of data blocks.

25. The computer readable storage media of claim 24, further comprising instructions to:
in response to the message, allocate the set of flags in the flag array as being associated with the plurality of data blocks.

26. The computer readable storage media of claim 25, further comprising instructions to identify the total number of the plurality of data blocks based on the message, wherein allocation of the set of flags is based on identification of the total number of the data blocks.

27. The computer readable storage media of claim 24, wherein the evaluating of the set of flags includes identifying that each of the set of flags stores a respective value indicating an opportunity to generate an interrupt on behalf of a corresponding data block.

28. The computer readable storage media of claim 24, further comprising instructions to:
correct a corrupted data block of the specified data, the corrector further to generate a signal indicating correction of the corrupted data block, wherein a flag value is stored in one of the set of flags based on the signal indicating correction of the corrupted data block.

29. The computer readable storage media of claim 24, wherein a flag value is stored in one of the set of flags in response to detection by the update unit of a completion of an exchange of a data block.

30. The computer readable storage media of claim 24, wherein the flag value is stored in the one of the set of flags further in response to detection by the transformation block of an indication of a data integrity of the data block.
